(19) United States
(12) Patent Application Publication
(10) Pub. No.: US 2009/0319892 A1
(43) Pub. Date: Dec. 24, 2009

(54) Controlling the Motion of Virtual Objects in a Virtual Space

(76) Inventors: Mark Wright, Edinburgh (GB); Peter Ottery, Edinburgh (GB)

Correspondence Address: HARRINGTON & SMITH, PC, 4 RESEARCH DRIVE, Suite 202, SHELTON, CT, 06484-6212, US

(21) Appl. No.: 12/223,771

(22) PCT Filed: Dec. 22, 2006
(86) PCT No.: PCT/GB2006/004881

§ 371 Date: Dec. 22, 2008

(30) Foreign Application Priority Data
Feb. 10, 2006 (GB) 0602689.2

(51) Int. Cl. G06F 3/01

(52) U.S. Cl. 715/701; 715/850

(57) ABSTRACT

A control system including: a device operable to enable a user to provide directional control of a virtual object by positioning a representation of the device within a virtual space and operable to provide force feedback to the user; a display apparatus for presenting to a user the virtual space including the virtual object and the representation of the device; and a controller, responsive to the relative positions of the virtual object and the representation of the device in the virtual space, for controlling motion of the virtual object through the virtual space and the force feedback provided to the user.

### FIELD OF THE INVENTION

Embodiments of the present invention relate to controlling the motion of virtual objects in a virtual space. One embodiment relates to the use of haptics for improving the manipulation of a virtual body. Another embodiment improves the animation of virtual objects.

### BACKGROUND TO THE INVENTION

3D virtual environments, such as Computer Aided Design and Animation applications, are related to the real world in that they involve models of 3D objects. These virtual representations are different from the real world in that they are not physical and usually are only accessible through indirect means. People learn to manipulate real objects effortlessly but struggle to manipulate disembodied virtual objects.

Haptics is the term used to describe the science of combining tactile sensation and control with interaction in computer applications. By utilizing particular input/output devices, users can receive feedback from computer applications in the form of felt sensations.

It would be desirable to use haptics to improve the manipulation of digital objects.

When specifying complex mechanisms in CAD (Computer Aided Design) and CAE (Computer Aided Engineering) systems, or moving complex articulated objects or characters in Animation systems, designers and animators find it useful to move the object/character around. Typically, a user will click on the object with a mouse and drag the mouse pointer across the screen. As the user does this the object appears to be dragged around too with joints moving to accommodate the desired motion.

This movement must embody and respect the physical constraints of these objects. Such constraints may consist of joints with limited degrees of freedom or positions and contacts which must be maintained. The problem of working out how to move the joints of such structures when given a desired movement of the structure is called “inverse” kinematics.

To provide the desired illusion of dragging the character or mechanism around, the inverse kinematics problem must be solved in real time. For simple configurations in low dimensions there are closed form analytical solutions to the problem. For complex systems in higher dimensions there are no simple solutions and some form of iterative technique is required. In practical situations the solutions can easily become unstable or take too long.

It would be desirable to provide for improved animation of virtual objects.

In a conventional computer aided design (CAD) or animation tool the input (mouse) and display (screen) are 2D whereas typically the objects that are being manipulated are 3D in nature. This means there is a mismatch between the control space (2D mouse coordinates) and the task space (3D object space). To allow the user to specify arbitrary orientations and positions of the objects various arbitrary mode changes are required which are a function of this interface/task mismatch and nothing to do with the task itself. For example translation and rotation may be split into two distinct modes and only one of these can be changed at a time. A user is forced to switch modes many times and can take a long time to achieve a result which in the real world would be a simple rapid effortless action.

It would be desirable to improve the efficiency of interacting with virtual objects by providing a 3D interface that does not exhibit a interface/task mismatch.

### BRIEF DESCRIPTION OF THE INVENTION

According to one embodiment of the invention there is provided a control system comprising: a device operable to enable a user to provide directional control of a virtual object by positioning a representation of the device within a virtual space and operable to provide force feedback to the user; a display device for presenting to a user the virtual space including the virtual object and the representation of the device; and control means, responsive to the relative positions of the virtual object and the representation of the device in the virtual space, for controlling motion of the virtual object through the virtual space and the force feedback provided to the user.

According to another embodiment of the invention there is provided a computer program comprising computer program instructions for: determining a position of a representation of a force feedback device within a virtual space;

determining a position of a virtual object within the virtual space; calculating a force feedback control signal for controlling a force feedback device, the control signal being dependent upon the relative positions of the virtual object and the representation of the force feedback device in the virtual space, and controlling motion of the virtual object through the virtual space in dependence upon the relative positions of the virtual object and the representation of the force feedback device in the virtual space.

According to another embodiment of the invention there is provided a control method comprising: determining a position of a representation of a force feedback device within a virtual space; determining a position of a virtual object within the virtual space; calculating a force feedback control signal for controlling a force feedback device, the control signal being dependent upon the relative positions of the virtual object and the representation of the force feedback device in the virtual space, and controlling motion of the virtual object through the virtual space in dependence upon the relative positions of the virtual object and the representation of the force feedback device in the virtual space.

According to another embodiment of the invention there is provided a method of animation comprising: dividing animation time into a plurality of intermediate times and at each intermediate time performing the following steps:

a) calculating a virtual force that is required to move from a current configuration of virtual objects at the current intermediate time to a desired end configuration of virtual objects at an end time; and
b) controlling the motion of the virtual objects through a virtual space between the current intermediate time and the next intermediate time by simulating the application of the calculated virtual force to the current configuration of virtual objects and by calculating the resultant motion of the configuration of virtual objects.

According to another embodiment of the invention there is provided a computer program comprising computer program instructions which when loaded into a processor enable the processor to: divide an animation time into a plurality of intermediate times and at each intermediate time perform the following steps:

a) calculate a virtual force that is required to move from a current configuration of virtual objects at the current intermediate time to a desired end configuration of virtual objects at an end time; and
b) control the motion of the virtual objects through a virtual space between the current intermediate time and the next intermediate time by simulating the application of the calculated virtual force to the current configuration of virtual objects and by calculating the resultant motion of the configuration of virtual objects.

According to another embodiment of the invention there is provided an animation system comprising: means for dividing an animation time into a plurality of intermediate times; means for setting a current intermediate time as an initial intermediate time and for setting a current configuration of virtual objects as an initial configuration of virtual objects; means for calculating a virtual force that is required to move from the current configuration of virtual objects at the current intermediate time to a desired end configuration of virtual objects at an end time; means for controlling the motion of the virtual objects through a virtual space between the current intermediate time and the next intermediate time by simulating the application of the calculated virtual force to the current configuration of virtual objects and by calculating the resultant motion of the configuration of virtual objects; and means for resetting the current intermediate time as the next intermediate time and for resetting the current configuration of virtual objects.

According to some embodiments of the invention, the motion of virtual objects is controlled by apply a calculated virtual force to the virtual object. In one embodiment, this virtual force arises from the position of a representation of a force feedback device in a virtual space relative to the position of the virtual object. In another embodiment, the virtual force arises from the need to move toward a specified end configuration.

In embodiments of the invention, a virtual force is calculated that is suitable for moving a virtual object to a defined position in a defined time. The motion of the virtual object through the virtual space is controlled by simulating the application of the virtual force to the virtual object and by calculating, using kinematics, its resultant motion. The resultant motion may be dependent upon programmable characteristics of the virtual space, such as constraints and environmental forces, that affect motion within the virtual space.

It is possible to give a virtual object some embodied physical characteristics using physics modelling and to use haptics to sense these characteristics. This can make CAD and Animation packages more intuitive and efficient to use.

By defining constraints and environmental forces, users can interact with dynamic objects intuitively and the natural compliance of the real world can be modelled.

Users of the system will be able to work in a virtual environment using real-world techniques, allowing them to use the tacit knowledge of their craft with the added benefits of using digital media.

The use of 3D imaging takes advantages of the benefits of real world interactions but in a virtual space. Co-location of the representation of a haptic device and the haptic device itself makes use of the haptic device more intuitive.

### BRIEF DESCRIPTION OF THE DRAWINGS

For a better understanding of the present invention reference will now be made by way of example only to the accompanying drawings in which:

FIG. 1, schematically illustrates a haptic system 10;

FIG. 2 schematically illustrates the design of software;

FIG. 3 schematically illustrates a translation of a virtual object from a position A towards a position B during a time step;

FIG. 4 illustrates a FGVM algorithm for movement of a virtual object;

FIG. 5 illustrates how the system may be used for real time 3D simultaneous rotational and translational movement of arbitrarily complex kinematic structures;

FIG. 6 illustrates the movement of a virtual body and a stylus representation in a series of sequential time steps; and

FIG. 7 illustrates an ‘Inbetweening’ interpolation algorithm.

### DETAILED DESCRIPTION OF EMBODIMENTS OF THE INVENTION

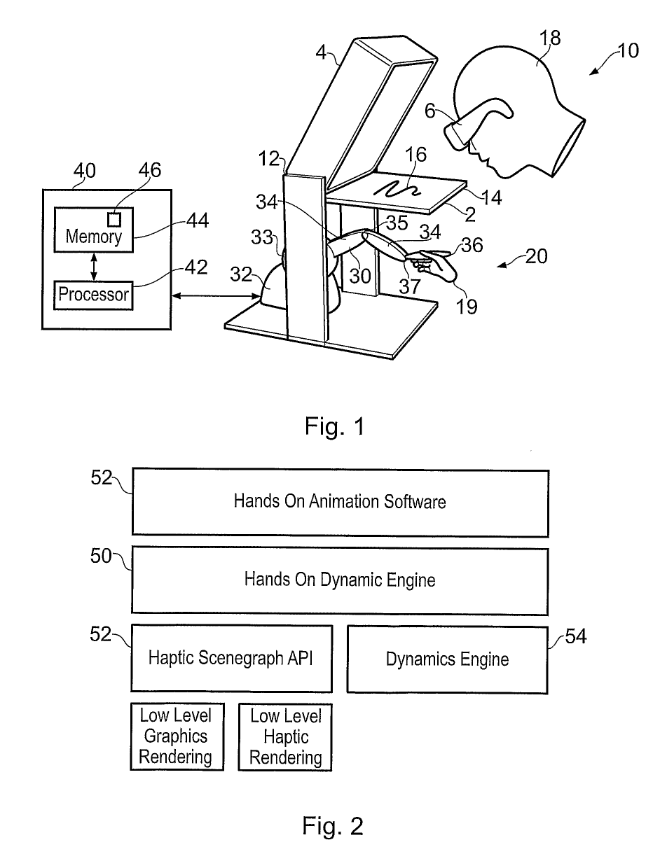

FIG. 1, schematically illustrates a haptic system 10. The system 10 comprises a visualisation system 12 comprising a display device 14 that is used to present a 3D image 16 to a user 18 as if it were located beneath the display device 14. The display device 14 is positioned above a working volume 20 in which a haptic device 30 is moved. The haptic device 30 can therefore be co-located with a representation of the device in the display device 14. However, in other implementations, the haptic device 30 and the representation of the haptic device may not be co-located.

In the illustrated example which is the 3D-IW from SenseGraphics AB, the visualisation system 12 provides a 3D image using stereovision. The visualisation system 12 comprises, as the display device 14, a semi-reflective mirror surface 2 that defines a visualisation area, an angled monitor 4 that projects a series of left perspective images and a series of right perspective images interleaved, in time, with the left perspective images onto the mirror surface 2 and stereovision glasses 6 worn by the user 18. The glasses 6 have a shutter mechanism that is synchronised with the monitor 4 so that the left perspective images are received by a user's left eye only and the right perspective images are received by a user's right eye only.

Although in this example, the representation of the haptic device is provided in stereovision this is not essential. If stereovision is used, a autostereoscopic screen may be used so that a user need not wear glasses. Furthermore the display device 14 may be a passive device, such as a screen that reflects light, or an active device such as a projector (e.g. LCD, CRT, retinal projection) that emits light.

The haptic device 30 comprises a secure base 32, a first arm 34 attached to the base 32 via a ball and socket joint 33, a second arm 34 connected to the first arm via a pivot joint 35 and a stylus 36 connected to the second arm 34 via a ball and socket joint 37. The stylus 36 is manipulated using the user's hand 19. The haptic device 30 provides six degrees of freedom (DOF) input—the ability to translate (up-down, left-right, forward-back) and rotate (roll, pitch, yaw) in one fluid motion.

The haptic device 30 provides force feedback in three of these degrees of freedom (up-down, left-right, forward-back).

The haptic device 30, through its manipulation in six degrees of freedom, provides user input to a computer 40. The computer 40 comprises a processor 42 and a memory 44 comprising computer program instructions (software) 46. The software when loaded into the processor 42 from the memory 44 provides the functionality for interpreting inputs received from the haptic device 30 when the stylus 36 is moved and for calculating force feedback signals that are provided to the haptic device. The computer program instructions 46 provide the logic and routines that enables the electronic device to perform the methods illustrated in the figures.

The computer program instructions may arrive at the computer 40 via an electromagnetic carrier signal or be copied from a physical entity such as a computer program product, a memory device or a record medium such as a CD-ROM or DVD.

Using the human hand and arm, as a kinematic chain, one can grab and move objects in a three dimensional environment and perform complex transformations on the position and orientation of objects without thinking about the individual components of this transformation. The haptic device 30 allows the user 18 to perform such actions with a virtual object within the image 16.

FIG. 2 schematically illustrates the design of software 46. There are two levels 50, 52 of software built on top of an existing Haptic Device API 52 and an existing dynamics engine API 54.

The haptic device interface 52 used is H3D. This is a scene graph based API. Open Dynamics Engine (ODE) 54 is an open source library for simulating rigid body dynamics. It provides the ability to create joints between bodies, model collisions, and simulate forces such as friction and gravity.

The first software level 50 is a haptic engine. This uses results generated in the dynamics engine 54 such as collision detection, friction calculations, and joint interactions to control the data provided to the haptic API 52.

The second software level 52 is the high level interaction techniques that includes methods and systems for natural compliance, hybrid animation, creation and manipulation of skeletons and articulated bodies, and dynamic character simulations.

Force Guided Virtual Manipulation (FGVM) is the purposeful 3D manipulation of arbitrary virtual objects. A desirable state for the object is achieved by haptically constraining user gestures as a function of the physical constraints of the virtual world. The physically simulated constraints work together to aid the user in achieving the desired state. The system 10 models and reacts to the physical constraints of the virtual 3D world and feeds these back to the user 18 visually through the display device 14 and through force feedback using the haptic device 30. In FGVM, physical interactions and forces are not rendered in an arbitrary manner, as with general haptic systems, but in a specific way which aides the goal of the user.

The implementation of FGVM is comprised of two parts—translation and rotation. These two aspects differ in the forces needed to move the object and how they affect the user.

A translation is the linear movement along a 3D vector of a certain magnitude. In the case of FGVM, and in the physical world, it is necessary to apply a force to objects in order for them to move or rotate. The system 10 allows users to interact and manipulate dynamical virtual objects while giving the user a sense of the system and the state of the objects though force feedback.

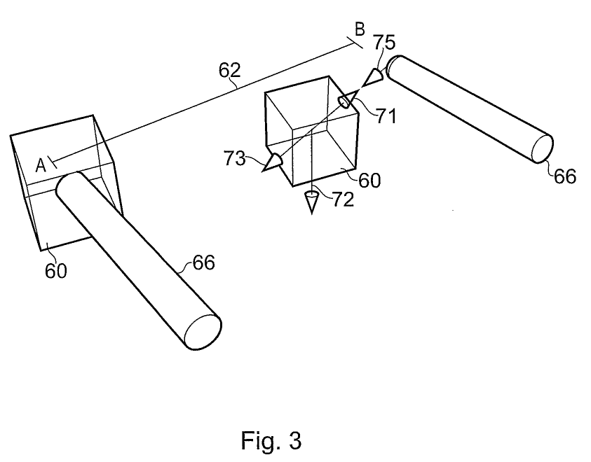

FIG. 3 schematically illustrates a virtual space as presented to a user using the display device 14. In the Figure, there is a translation 62 of a virtual object 60 from a position A towards a position B during a time step.

Initially, a stylus representation 66, which is preferably co-located with the real stylus 36 in the working volume 20, is linked with the centre of the virtual object 60. This may be achieved by moving the stylus tip 67 to the virtual object 60 and selecting a user input button on the stylus 36.

Selecting the user input results in selection of the nearest virtual object, which may be demonstrated visually by changing the appearance of the object 60.

When the user selects an object 60 a virtual link is created between the tip of the stylus representation 66 and the centre of the object 60. Then when the stylus representation 66 is moved, the linked virtual object 60 follows.

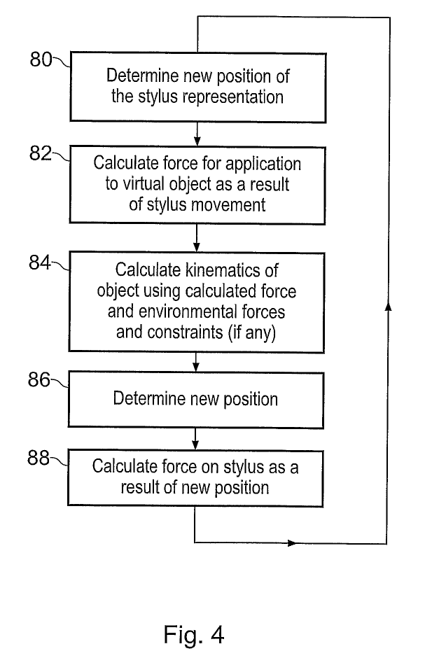

The translation or movement is controlled by a FGVM algorithm. The algorithm operates by dividing time into a series of steps and performing the method illustrated in FIG. 4 for each time step. The algorithm is performed by the haptics engine 50 using the dynamics engine 54.

First, at step 80, the algorithm determines the position of the stylus representation 66 for the current time step.

Then, at step 82, the algorithm calculates a virtual force 71 that should be applied to the virtual object 60 during the current time step as a result of the movement of the stylus representation 66 since the last time step. The force 71 should be that which would move the virtual object from it current position to the position of the stylus representation during a time step.

Thus, when the user moves the stylus representation 66 from the centre of the virtual object 60 to another position a virtual force 71 is immediately calculated for application to the virtual object 60 which will take the virtual object 60 to the tip of the stylus representation 66 in the next time step. This force is calculated through a simple equation of motion¹:

$$s = ut + \frac{1}{2} {at}^{2} \qquad ( 1 )$$

Where s is the distance traveled from the initial state to the final state, u is the initial speed, a is the constant acceleration, and t is the time taken to move from the initial state to the end state. We rearrange this equation to find the acceleration:

$$a = \frac{2 ( s - ut )}{{t}^{2}} \qquad ( 2 )$$

Finally, to find the force necessary to get the virtual object to the tip of the stylus representation the force is calculated as:

f=ma (3)

Where f is the force which needs be applied to the object, m is the mass of the object and a is the acceleration.

In the absence of any external factors acting on the virtual object 60, the virtual force which will be applied will be great enough to propel it to the stylus representation's tip in one time step. However, there may be other environmental forces acting on the virtual object that can modify its motion and thus prevent it from achieving its desired position. The environmental forces may emulate real forces or be invented forces.

At step 84, the kinematics of the virtual object 60 are calculated in the dynamics engine 54. The dynamics engine takes as its inputs parameters defining the inertia of the virtual object such as its mass and/or moment of inertia, a value for the calculated virtual force, and parameters defining the environmental forces and/or the environmental constraints.

In FIG. 3, two example environmental forces are shown. These forces are a friction force 73 and a gravitational force 72.

The friction force 73 is a force applied in the opposite direction to the virtual object's motion. It is proportional to the velocity of the virtual object. It is also linked with the viscosity of the virtual environment through which the virtual object moves. By increasing the viscosity of the virtual environment, the friction force will increase making it harder for the object to move through space. The viscosity of the environment may be variable. It may, for example, be low in regions where the virtual object should be moved quickly and easily and it may be higher in regions where precision is required in the movement of the virtual object 60.

A gravitational force 72 accelerates a virtual object 60 in a specified direction. The user may choose this direction and its magnitude.

Examples of constraints are definitions of viscosity or of excluded zones, such as walls, into which no part of the virtual object 60 may enter.

At step 86, the dynamics engine determines a new position for the virtual object and the virtual object is moved to that position in the image 16.

At step 88, the haptic engine 50 calculates the force 75 to be applied to the stylus 36 as a result of new position of the virtual object 60. The force 75 draws the stylus 36 and hence the stylus representation 66 towards the virtual space occupied by the centre of the virtual object 60.

The force 75 may be a ‘spring effect’ force that is applied to the tip of the stylus, and acts similarly to an elastic band whereby forces are proportional to the distance between the centre of the virtual object 60 and the stylus representation 66. The greater the distance between the virtual object 60 and the stylus representation 66 the greater the force 75 becomes.

The environmental forces 72, 73 prevent the virtual object 60 reaching its intended destination within a single time step. This translates to a resulting spring force 75 that is experienced by the user which in turn gives a sense of the environment to the user. For example, if a gravitational force is applied the user will get a sense of the object's mass when trying to lift it because the gravitational force acts on the object while it tries to reach the position of the stylus. Since the object cannot reach the stylus, the spring effect will be applied on the user proportional to the distance. With a higher gravitational force, the distance will be greater and thus so will the spring effect.

A rotation is a revolution of a certain degree about a 3D axis. The rotational component of the force guided manipulation is similar to the translation component, in that, as the configuration of the stylus representation 66 changes during a time step, the virtual object has a force applied to itself in order to reach the desired pose. However, it does differ in two ways:

Firstly, the calculated force required to transform the virtual object from its original orientation to the orientation of the stylus representation 66 is a torque force rather then a directional force. The method for achieving this force is applied in two parts. First, an axis of rotation is determined which is usable to rotate the virtual object to #the required orientation. Then the necessary force is calculated for rotating the virtual object about the rotation axis. The magnitude of the force is calculated by determining the rotational difference between the virtual object's current and desired orientation.

Secondly, there is no direct haptic feedback. Most commercially viable haptic devices implement a 6 DOF movement, 3 DOF force feedback. Although the device can move and rotate in all directions, the only forces that are exerted on the user are translation forces. Therefore, a direct sense of torque cannot be felt. However, the user can feel the torque though non direct interaction. During the rotation of an object about an axis, the centre of the object undergoes a translation. This force can be felt by the stylus through the translation component of FGVM.

Compliance is the property of a physical system to move as forces are applied to it. A useful real world context in which engineers can use “selective” compliance is in the reduction of uncertainty in positioning, mating and assembly of objects. FGVM uses modelled compliance of virtual objects to reduce uncertainty and complexity in their positioning in CAD and Animation tasks. The compliance makes the job much easier and quicker to achieve. Without compliance modelling object orientations and relationships have to be specified exactly. With compliance modelling positions are reached accurately and automatically as a result of compliant FGVM.

FGVM turns a high precision metric position and orientation task into a low precision topological behavioural movement. The positioning of a square block into a corner in a CAD package would normally require precise specification of the orientation and position of the cube to the corner where orientation and position are the metric properties which must be exactly specified. In FGVM this onerous procedure is replaced by an initial definition of constraints which define the ‘walls’ that intersect at the corner and then a rapid and imprecise, natural force guided set of movements. First the cube is brought down to strike any part of the table top (defined as a constraint) on a corner. It may then rotate onto an edge or directly onto a face. The cube can then be slid so a vertical edge touches the wall (defined by a constraint) near the corner. The cube can then be pushed so it rotates and aligns neatly to the corner. All this is achieved in a continuous rapid subconscious motion from the user without any detailed thought. Thus FGVM solves the problem of specifying the position of virtual disembodied objects by modelling the natural compliance of the real world and drawing on human motor skills learnt since childhood.

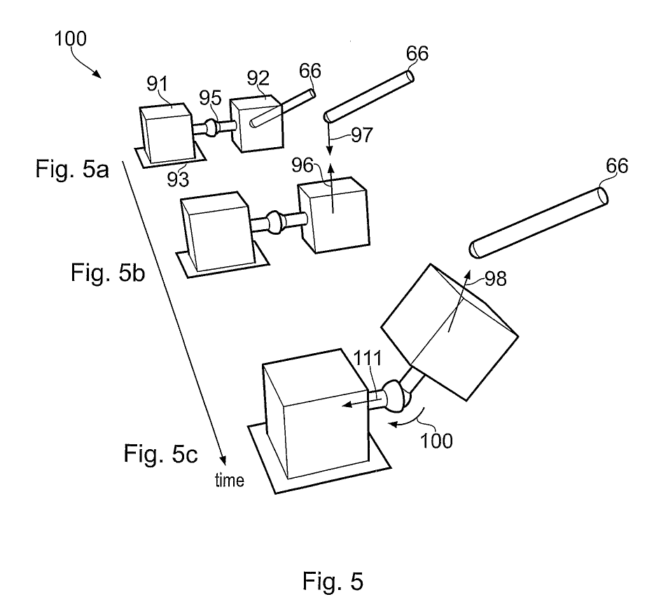

FIG. 5 illustrates how the system 10 may be used for real time 3D simultaneous rotational and translational movement of arbitrarily complex kinematic structures. The Figure includes FIGS. 5A, 5B and 5C, each of which represents an articulated body 100 at different stages in its movement.

The articulated body 100 comprises a first body portion 91 which is fixedly connected to a fixed plane 93, and a second body portion 92 which is movable with respect to the first body portion 91 about a ball and socket joint 95 that connects the two body portions. The ball and socket joint 95 allows a full range of rotation.

Referring to FIG. 5B, a virtual force 96 is generated on the second body portion 92 using FGVM controlled by the stylus 66 as previously described. A virtual force 96 is applied to the second body portion 92 as a consequence of the position of the stylus representation 66. A reactive force 97 is applied to the stylus 36 controlled by the user 18.

The constraints used in the algorithm illustrated in FIG. 4, define the limitations of movement of the second body portion 92 relative to the first body portion 91. They may also define the stiffness of the ball and socket joint 95 and its strength. The stiffness determines how much rotational movement of the second body portion 92 relative to the first body portion 91 is resisted. The strength determines how much virtual force the ball and socket joint can take before the second body portion 92 separates from the first body portion 91.

In the time step between FIGS. 5B and 5C, the algorithm calculates the virtual force 96, calculates the kinematics of the second body portion 92 using the calculated virtual force 96 and the defined constraints, determines the new position for the second body portion 92 and moves the second body portion 92 to that position and then calculates the new reactive force 97 on the stylus 36.

In FIG. 5C, the virtual forces having an effect as a result of the position of the stylus representation 66 and the defined constraints and environmental forces are illustrated. A virtual force 98 is applied to the second body portion 92. There is a frictional resistive force 100 that resists rotational movement of the second body portion 92 and a virtual force 111 that is applied to keep the two parts of the joint together.

As described previously, a virtual drive force is calculated as a consequence of the distance of the stylus representation 66 from a selected body portion. A dynamics engine is then used to generate reactive or environmental forces. The engine is used to determine the movement of the selected body as a forward problem, where the body reacts to the applied forces but its movement respects any defined constraints. A reactive force is applied to the stylus 36 that is also dependent upon the distance between the selected body and the stylus representation 66. This approach changes the problem of determining the state of the system from an inverse analytic geometric problem into a physics based iterative forward problem.

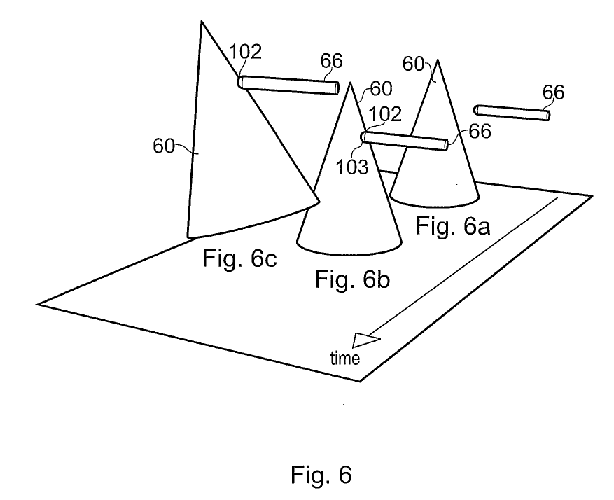

FIG. 6 illustrates the movement of a virtual body 60 and a stylus representation in a series of sequential time steps. The first time step is illustrated as FIG. 6A. At this point in time the stylus representation 66 is moving towards the virtual body 60. The second time step is illustrated in FIG. 6B. At this point in time the stylus representation 66 is coupled with a surface portion 103 of the virtual body via a ‘linker’ 102. The third time step is illustrated in FIG. 6. As the stylus representation 66 is moved away from the surface portion the virtual body tries to follow.

The linker is a virtual ball and socket joint that buffers between the stylus representation 66 and the virtual body 60. It is dynamically linked to the tip of the stylus representation 66 according to the FGVM algorithm. Consequently, the linker body 102 is constantly trying to move itself to the tip of the stylus and the stylus feels a spring effect force attaching it with the linker body. Therefore all interactions with the scene are through this linker body rather then the stylus itself. This gives the system the ability to change the interaction characteristics between the linker body and the virtual objects while still maintaining haptic feedback to the user though the spring effect force. It is possible to turn off collisions and interactions between the all objects and the linker body.

When the user wants to interact with a virtual object they simply move to the object and signal to the system thorough a key or button press. At this point a ball and socket joint link 102 is created between the selected surface portion 103 of the object 60 and the stylus representation 66. The linker body 102 remains fixed to the selected surface portion 103 of the body until de-selection. The linker body 102 will now experience the virtual object's reaction to such external factors including collisions, friction and gravity and thus this translates to the user though the spring effect force on the stylus 36 as the linker body 102 tries to move away from the stylus representation 66.

The ability to create joints over the entire virtual object surface and not just at its centre allows users to use natural compliances to direct where forces are to be applied on objects. We can then push, pull, lift, rotate, and hit objects at the exact area that we would normally perform these manipulations in real life. Giving users the ability to naturally interact with objects as they would in real life gives the system 10 a distinct advantage over more traditional methods of computer animating and design, where the user has to infer from their memories of real life interactions how objects might move or behave.

The system 10 has particular use in a new animation technique. In this techniques, the animator specifies particular instances of the animation called Key Frames. Then other frames are created to fill in the gaps between these key frames in a process called “inbetweening”. The new animation technique enables automated inbetweening using 3D virtual models which can be viewed, touched and moved in 3D using the system 10. A virtual object is created for each animation object that moves or is connected to an object that moves.

The system is effectively a cross between conventional 3D computer animation, using a 2D screen and 2D mouse, and real world Claymation where real 3D clay or latex characters are moved in 3D. The system introduces a further new form of animation “dynamic guide by hand”, where animators can touch and change animations as they play back and feel forces from this process.

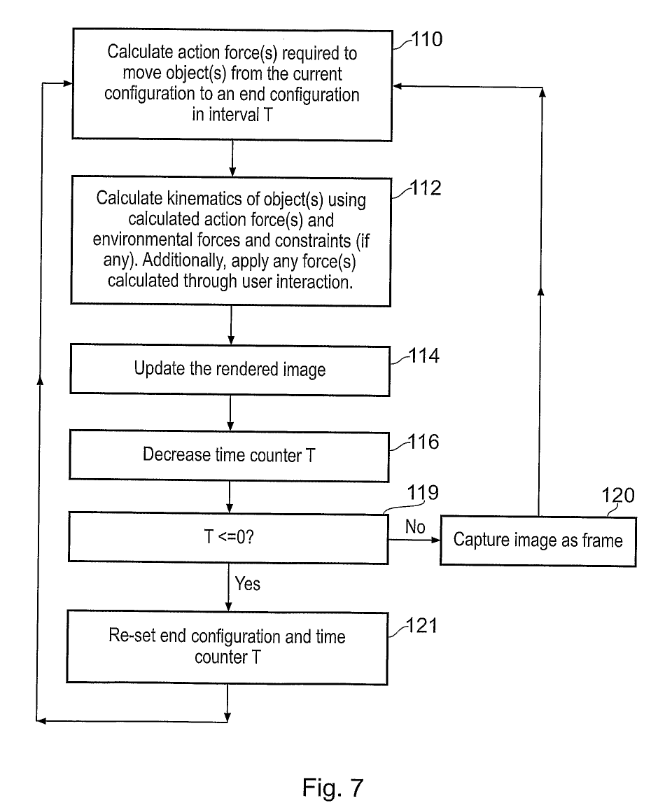

Inbetweening is carried out by an interpolation algorithm such as that illustrated in FIG. 7.

At step 110, the algorithm calculates the virtual action force(s) that are required to move the object(s) in an animation scene from their current position (initially Key Frame n to the position(s) they occupy in an animation scene at Key Frame n+1. The configuration of the objects at Key Frame n+1 is an ‘end configuration’. The virtual action force may be calculated as described in relation to step 82 of FIG. 4, except that at the end of a time interval T the object(s) should have moved to their positions in the end configuration rather than the position of a stylus representation.

Then at step 112, the algorithm calculates the kinematics of the object(s) using the calculated action force(s) and environmental forces and constraints (if any). This step is similar to that described in relation to step 84 of FIG. 4.

The constraints may be defined by a user. They will typically define hard surfaces, viscosity etc. The environmental forces may be predetermined as described in relation to FIG. 4 or may be dynamically adapted, for example, using the stylus 36. For example, the user may be able to apply an additional force on a particular object by selecting that object for manipulation using the stylus representation 66 and then moving the stylus representation 66. The additional force could be calculated as described in relation to steps 80 and 82 of FIG. 4. The additional force applied to the selected object as a consequence of moving the stylus representation 66 would move the selected object towards the tip of the stylus representation. A reaction force would also be applied to the stylus 36.

The algorithm, at step 114, allows the object(s) to move according to the calculated kinematics for one frame interval. The resulting new configuration of objects is displayed as image 16 as the next ‘inbetween’ frame.

If the remaining time interval indicated by T is less then or equal to 0 (step 119) the end configuration is set to the configuration of objects at Key Frame n+2. Key frame n+1 is set to the current configuration of the object(s) (which may be the original key frame n+1 position or a new position determined by user interaction and constraint forces preventing the original key frame being reached in the time interval) and the time counter T is set to the new time interval between Key Frame n+1 and Key Frame n+2. The process then returns to step 110. If the time counter T is greater then 0, the process moves to step 120 where the resultant configuration of objects is captured as an inbetween frame. The process then returns to step 110 and the process is repeated to obtain the next inbetween frame.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A control system comprising:
a device operable to enable a user to provide directional control of a virtual object by positioning a representation of the device within a virtual space and operable to provide force feedback to the user;
a display apparatus for presenting to a user the virtual space including the virtual object and the representation of the device; and
a controller configured to, responsive to the relative positions of the virtual object and the representation of the device in the virtual space, control motion of the virtual object through the virtual space and the force feedback provided to the user.

2. (canceled)

3. A system as claimed in claim 1 wherein the controller is operable to control the motion of the virtual object so that it moves toward the representation of the device more quickly when the separation between the virtual object and the representation of the device is greater.

4. A system as claimed in claim 1, wherein the controller is operable to control the force feedback provided to the user so that it forces the device in a direction which would move the representation of the device through the virtual space towards the virtual object if not resisted by the user.

5. A system as claimed in claim 4, wherein the feedback force is greater when the separation between the virtual object and the representation of the device is greater.

6. (canceled)

7. (canceled)

8. A system as claimed in claim 1, wherein the controller is operable to control the motion of the virtual object through the virtual space by simulating the application of a virtual force to the virtual object and by calculating the resultant motion.

9. A system as claimed in claim 8, wherein the virtual force is directed toward the position of the representation of the device within the virtual space and is dependent upon the distance between the virtual object and the representation of the device in the virtual space.

10. A system as claimed in claim 9, wherein the calculation of the resultant motion is dependent upon programmable characteristics of the virtual space that affect motion within the virtual space wherein programmable characteristics are arranged to aid completion of a predetermined location task.

11. (canceled)

12. A system as claimed in claim 8, wherein the calculation of the resultant motion is dependent upon one or more factors selected from the group comprising: a simulated inertia for the virtual body; environmental forces applied to the virtual body; defined constraints.

13-25. (canceled)

26. A control method comprising:
determining a position of a representation of a force feedback device within a virtual space;
determining a position of a virtual object within the virtual space;
calculating a force feedback control signal for controlling a force feedback device, the control signal being dependent upon the relative positions of the virtual object and the representation of the force feedback device in the virtual space, and
controlling motion of the virtual object through the virtual space in dependence upon the relative positions of the virtual object and the representation of the force feedback device in the virtual space.

27-33. (canceled)

34. A method of animation comprising:
a) user control, during an animation sequence, of a virtual force for application to a current configuration of virtual objects at a current time; and
b) controlling the motion of the virtual objects through a virtual space between the current time and a future time by simulating the application of the user controlled virtual force to the current configuration of virtual objects and by calculating the resultant motion of the configuration of virtual objects.

35. A method as claimed in claim 34, wherein the configuration of virtual objects comprises a plurality of articulated virtual objects.

36. (canceled)

37. A method as claimed in claim 35, wherein the calculation of the resultant motion is dependent upon programmable characteristics of the virtual space that affect motion within the virtual space.

38. A method as claimed in claim 37, wherein the calculation of the resultant motion is dependent upon a simulated inertia and environmental forces applied to the virtual body.

39. (canceled)

40. A method as claimed in claim 38, wherein an environmental force is applied to a selected portion of the configuration of virtual objects and is directed toward a position of a representation of a device within the virtual space that is movable by a user and wherein the environmental force is dependent upon the distance between the selected portion of the configuration of virtual objects and the representation of the device in the virtual space.

41-42. (canceled)

43. A method as claimed in claim 40, wherein the selected portion of the configuration of virtual objects moves through the virtual space towards the representation of the device more quickly when the separation between the selected portion of the configuration of virtual objects and the representation of the device is greater.

44-45. (canceled)

46. A method as claimed in, claim 43 further comprising controlling a force feedback device, which is used by a user for controlling the magnitude and direction of the virtual force, so that it applies a reactive feedback force to a user dependent upon the magnitude and direction of the user controlled virtual force.

47. A method as claimed in claim 34, further comprising controlling a force feedback device, which is used by a user for controlling the position of a representation of the device in the virtual space, so that it applies a feedback force to a user in a direction that would cause, if unopposed by the user, the representation of the device to follow a selected portion of the configuration of virtual objects as it moves during the animation time.

48. A method as claimed in claim 47, wherein the feedback force is greater when the separation between the selected portion of the configuration of virtual objects and the representation of the device is greater.

49. A method as claimed in claim 48, wherein the virtual space is three dimensional space and wherein a force feedback device and a representation of the force feedback device in the virtual space are substantially co-located.

50-52. (canceled)

53. An animation system comprising:
a user input device for controlling a virtual force for application to a current configuration of virtual objects at a current time;
a display device for displaying the configuration of virtual objects in a virtual space; and
a controller for controlling the motion of the virtual objects through the virtual space between the current time and a future time by simulating the application of the user controlled virtual force to the current configuration of virtual objects and by calculating the resultant motion of the configuration of virtual objects through the virtual space.
